(19) United States
(12) Patent Application Publication
(10) Pub. No.: US 2015/0155794 A1
(43) Pub. Date: Jun. 4, 2015

(54) Short Circuit Protection

(71) Applicant: Control Techniques Limited, Newtown (GB)

(72) Inventor: Sanping LONG, Shenzhen (CN)

(21) Appl. No.: 14/476,390

(22) Filed: Sep. 3, 2014

(30) Foreign Application Priority Data
Jul. 12, 2013 (CN) 201310293949.0

(51) Int. Cl. H02M 7/06; H02M 1/14

(52) U.S. Cl. CPC H02M 7/062; H02M 1/14

(57) ABSTRACT

A method and apparatus are provided for short circuit protection in a DC current source. A rectifying circuit arranged to generate a DC output can coupled to an AC source and a capacitor filter circuit can be provided to smooth the DC output. A short circuit detection unit can also be provided for monitoring at least one voltage across the capacitor filter circuit and generating a fault signal. A controller can then limit current through the capacitor filter circuit when the fault signal implies that the monitored voltage has fallen below a threshold value.

### CROSS-REFERENCE TO RELATED APPLICATION

This application claims the benefit and priority of Chinese Patent Application No. 201310293949.0 filed Jul. 12, 2013. The entire disclosure of the above application is incorporated herein by reference.

### FIELD OF THE INVENTION

The present invention relates to the provision of protection against short circuits in a DC source. In particular, but not exclusively, the present invention relates to the provision of protection against failure of capacitors in a capacitor filter circuit used in combination with a three-phase rectifying circuit.

### BACKGROUND

In the transmission of electrical power, it is often necessary to convert an AC supply to create a DC source. Circuits for this purpose are known as rectifying circuits. A typical rectifying circuit may comprise a diode or diodes to ensure a constant polarity in the output signal. A capacitor filter circuit may then be used to smooth the output signal to provide a stable DC output.

Rectifying circuits may be single phase or multi-phase. Small power rectifying circuits for use in domestic setting are often single phase, but for larger power applications multi-phase rectifying circuits, in particular three-phase rectifying circuits, are common.

In a three-phase bridge rectifying circuit, six diodes are provided. Each phase of the supply is delivered between a pair of diodes in series, and the resulting output comprises six pulses over the cycle.

It has been proposed to couple such a rectifying circuit to a capacitor filter circuit that comprises one or more arrays of parallel capacitors. That is to say, each array of capacitors may be coupled in series but within the array multiple capacitors may be provided in parallel. This can ensure sufficient capacitance is available to manage the DC output to desired levels while using available components.

Should one or more capacitors within an array fail this will cause a short circuit, meaning that the remaining capacitors within that array are bypassed. As a result, the voltage across the capacitor filter circuit will fall on the remaining arrays of capacitors coupled to the rectifying circuit. This increased voltage across the remaining arrays of capacitors will eventually lead to failure, resulting in a surge current that is likely to damage the rectifying circuit.

To mitigate this problem, fuses are often provided. In particular, it is common to provide a fuse on each on the three phase inputs of the AC supply, together with a fast fuse coupled in series with the capacitor filter circuit. When a short circuit occurs, one or more of these fuses are blown by the increased current to prevent damage to more valuable components, such as the rectifying circuit capacitor.

In many cases, suitable fuses for use in a failure condition are both expensive and relatively large in size. Furthermore, the selection of an appropriate fuse is critical. If the fuse capacity is too small, the fuse may be too easily blown when a large load, for example, is placed on the system. On the other hand, if the fuse capacity is too large, then it may not provide adequate protection to components in the system. The fast fuse coupled in series with the capacitor filter circuit may often be implemented in a combined unit, which can also complicate maintenance after a failure event.

### SUMMARY OF THE INVENTION

According to a first aspect of the present invention, there is provided a direct current source, comprising:
a rectifying circuit coupled to an AC source, the rectifying circuit being arranged to generate a DC output;
a capacitor filter circuit for smoothing the DC output of the rectifier circuit, the capacitor filter circuit comprising at least one capacitor;
a short circuit detection unit for monitoring at least one voltage across the capacitor filter circuit, the short circuit detection unit being arranged to generate a fault signal which depends on the monitored voltage; and
a controller for limiting current through the capacitor filter circuit when the fault signal implies that the monitored voltage has fallen below a threshold value.

The present invention can avoid damage to other features of the source when elements of a capacitor filter circuit fail, and can do so without the need to rely on fuses. This is particular useful in large power applications where selection of appropriate fuses is difficult and such fuses are both large and expensive. The present invention can in particular recognise the shorting of elements, such as capacitors, in the capacitor filter circuit since this leads to a reduction in measured voltage across such a capacitor. The controller can then limit the current through the capacitor filter circuit, which can mitigate the risk of further failures in the capacitor filter circuit, meaning that damage to other components in the source, such as the rectifying circuit, becomes less likely. This can be done by reducing the load on the capacitor filter circuit. Reduction in the load on the capacitor filter circuit can mean the reduction in the potential difference across the capacitor filter circuit.

In preferred embodiments, the capacitor filter circuit comprises a plurality of capacitor arrays, each capacitor array being connected in series and comprising one or more capacitors connected in parallel, and wherein the short circuit detection unit is arranged to monitor voltage across one or more of the capacitor arrays. A DC output can be taken from across each array. When a capacitor in one array is shorted, the entire array may be shorted since it is in a parallel configuration. However, remaining arrays in the filter circuit will then be required to withstand the full supply, and this will give rise to current surges through the source. If any capacitor's working voltage is more than its rating value, fuses in the system may not be tripped until elements of the rectifying circuit and/or capacitor filter circuit break down. The present invention can avoid this by limiting the current through the capacitor array when a reduced voltage is detected across any one array.

In preferred embodiments, each capacitor array comprises at least two capacitors in parallel. This allows increased capacitance in each array and the in the capacitor filter circuit overall, thereby increasing the smoothing effect on the DC output.

The controller can limit the current on the capacitor filter circuit connecting a resistive element in series connection between the rectifying circuit and the capacitor filter circuit. The resistive element may be a resistor, but may alternatively be another component with resistive properties. In one preferred embodiment, the source further comprises a soft start circuit comprising a switch and a resistor in parallel, wherein the controller is adapted to open the switch when the fault signal implies that the monitored voltage has fallen below a threshold value. Accordingly, when the controller recognises that the monitored voltage has fallen, it effectively introduces a previously bypassed resistor into the circuit. The soft start circuit can also limit surge current during initiation of the source, to avoid excessive currents when the capacitors within the capacitor filter circuit are initially charged.

In addition or in alternative to introducing resistive elements to bear load that would otherwise be borne by the capacitor filter circuit in order to limit current on the capacitor filter circuit, the controller may limit current on the capacitor filter circuit by reducing or disconnecting the AC source signal from the rectifying circuit.

In preferred embodiments, the short circuit detection unit comprises one or more opto-couplers. Opto-couplers are particularly appropriate in the context of the present invention as they are able to offer a switched result, thereby offering a clear distinction in the fault signal when the monitored voltage falls below a threshold value. In particular, a light signal within the opto-coupler is either present or not depending on an applied voltage, thereby enabling switching in dependence on this value. A voltage divider circuit may be used to select an appropriate proportion of the voltage across a capacitor array for application to a light emitting diode within an opto-coupler. If the voltage applied to the light emitting diode is sufficient then it will be turned on, causing a switch to be closed, while if the voltage falls below that value the switch will be open, modifying the fault signal output from the short circuit detection unit.

Preferably, a fault filter circuit is coupled to the output of the short circuit detection unit, the fault filter circuit being arranged to remove transient effects from the fault signal. Since the source signal applied to the rectifying circuit is alternating, the voltage across the capacitor filter circuit will include a time varying component of some magnitude, despite the smoothing effects of the capacitor filter circuit itself. To avoid such transient effects causing the controller to act unnecessarily, such transient effects may be filtered from the fault signal prior to reaching the controller using a fault filter circuit. Filter circuits are known in the art and may comprise appropriate choices of capacitors and resistors.

Preferably, the rectifying circuit is a three-phase rectifying circuit. As such, the rectifying circuit can be used to handle a three-phase AC source signal. Such signals are particularly appropriate for carrying large voltages, of the kind required for industrial processes. Moreover, the rectifying circuit is preferably a full wave rectifying circuit, thereby ensuring that the majority of energy within the source signal is not lost.

According to a second aspect of the present invention, there is provided a method for providing a DC source, comprising:
rectifying an AC signal to provide a DC output;
smoothing the DC output using a capacitor filter circuit, the capacitor filter circuit comprising at least one capacitor;
monitoring at least one voltage across the capacitor filter circuit, and generating a fault signal which depends on the monitored voltage; and
limiting the current through the capacitor filter circuit when the fault signal implies that the monitored voltage has fallen below a threshold value.

Like the first aspect, the method of the second aspect allows the assessment of errors in a capacitor filter circuit and corresponding action to be taken without the need for fuses. Preferred features of the first aspect may equally be applied to the second aspect.

### BRIEF DESCRIPTION OF THE DRAWINGS

Embodiments of the present invention will now be described with reference to the accompanying drawings, in which:

FIG. 1 illustrates a prior art DC source comprising a rectifying circuit, a soft start circuit and a capacitor filter circuit;

FIG. 2 illustrates a DC source according to a first preferred embodiment of the present invention;

FIG. 3 illustrates a DC source according to a second preferred embodiment of the present invention;

FIG. 4 illustrates a DC source according to a third preferred embodiment of the present invention;

FIG. 5 illustrates a DC source according to a fourth preferred embodiment of the present invention;

FIG. 6 illustrates a DC source according to a fifth preferred embodiment of the present invention; and

FIG. 7 illustrates a DC source according to a sixth preferred embodiment of the present invention.

### DETAILED DESCRIPTION

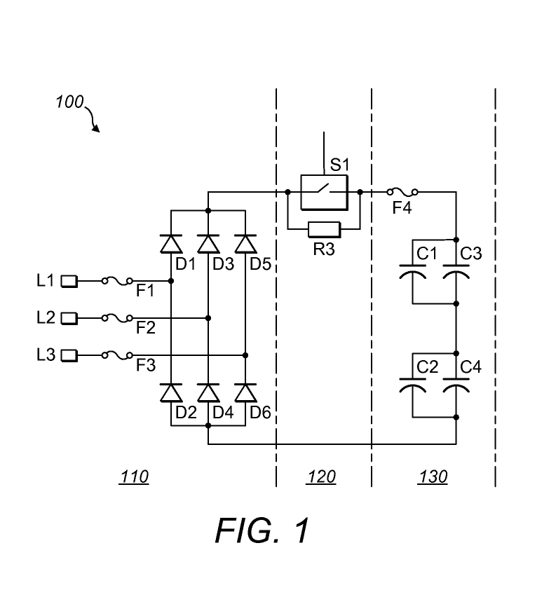

FIG. 1 shows a typical DC (direct current) source 100. The source 100 comprises a three-phase bridge rectifying circuit 110, a soft start circuit 120 and a capacitor filter circuit 130. An AC (alternating current) source signal is provided to the three-phase bridge rectifying circuit 110 while a DC output source may be obtained from the capacitor filter circuit 130. The soft start circuit 120 is used to control initiation of the DC source 100.

The three-phase bridge rectifying circuit 110 comprises three input source couplings L1, L2, L3. Each source coupling L1, L2, L3 receives an AC supply with a relative phase offset. The rectifying circuit 110 further comprises a source fuse F1, F2, F3 coupled to each source coupling L1, L2, L3. The rectifying circuit 110 further comprises an array of diodes D1, D2, D3, D4, D5, D6.

The rectifying circuit 110 acts to convert the three phase AC supply received at source couplings L1, L2, L3 into a DC output, since the diodes D1, D2, D3, D4, D5, D6 will only pass current of one polarity.

The soft start circuit 120 is used to prevent too large a current at initiation of the DC generating circuit 100. The soft start circuit comprises a resistor R3 and a switch S1. At the moment of initiation, switch S1 is in an open position, thereby causing current to pass through resistance R3, limiting surge current. After a period of time, the switch S1 is closed, thereby shorting resistor R3 and avoiding unwanted power loss. This operation prevents an excessive surge when the DC generating circuit is initiated, as the resistor R1 is only bypassed after the capacitor filter circuit 130 has been initiated.

The capacitor filter circuit 130 comprises capacitors C1, C2, C3, C4. These are arranged in a first parallel array of capacitors C1, C3 and a second parallel array of capacitors, C2, C4. Each array is connected in series.

The capacitors C1, C2, C3, C4 act to smooth the DC signal received from the rectifying circuit 110 to provide a DC output of a relatively constant potential difference. The soft start circuit 120 is used to reduce the surge current as the capacitors C1, C2, C3 and C4 initially charge.

The capacitor filter circuit 130 also comprises a fast fuse F4. The fast fuse F4 is intended to protect the other elements of the capacitor filter circuit in the event of failure.

One failure condition is that one of the capacitors C1, C2, C3, C4 may be shorted. In such a condition, the other capacitor within the array containing the shorted capacitor will be bypassed. For example, if capacitor C1 is shorted, the capacitor C3 is bypassed. This leaves the remaining array of capacitors to withstand the full voltage output by the rectifying circuit 110. For example, if capacitor C1 is shorted, then this full voltage will be placed across capacitor C2 and capacitor C4.

The full voltage across capacitors C2 and C4 exceeds the rating voltage of these components, and will cause the generation of heat and ultimately the failure of capacitors C2 and C4. This would result in a large current which could potentially damage other elements in the system, particularly the three phase bridge rectifying circuit 110. Fuses F1, F2, F3 and F4 are provided to reduce the danger of such damage, since they are intended to blow before other elements of the system.

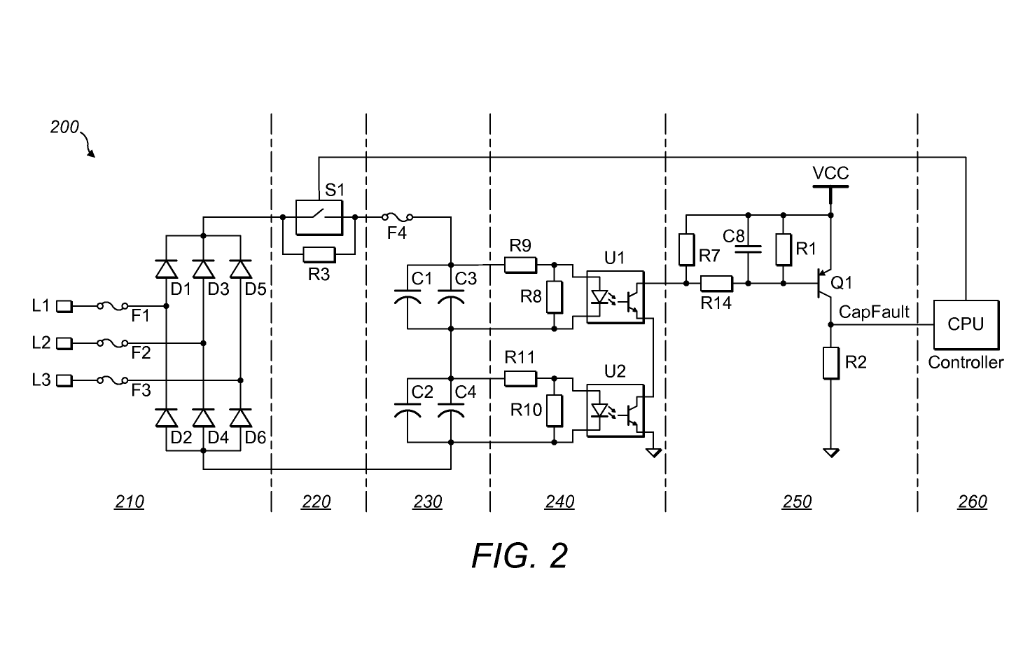

A first preferred embodiment of the present invention is shown in FIG. 2. Again, a DC source 200 is provided. The DC source 200 comprises a three-phase rectifying circuit 210, a soft start circuit 220 and a capacitor filter circuit 230 which are constructed and operate in the same function as three-phase rectifying circuit 110, soft start circuit 120 and capacitor filter circuit 130 respectively shown in FIG. 1.

In the preferred embodiment shown in FIG. 2, the AC supply provided at L1, L2, L3 may be a three phase 380V source. The capacitors C1, C2, C3, C4 each have a 2200 uF rating or other rating value.

The DC source 200 of the first preferred embodiment further comprises a short circuit detection unit 240, a fault filter circuit 250, and a controller 260.

The short circuit detection unit 240 comprises a first short circuit detection section coupled to the first array of capacitors C1, C3 and a second short circuit detection section coupled to the second array of capacitors C2, C4. Each detection section comprises a first resistor R9, R11 and a second resistor R8, R10. The first resistor R9, R11 and the second resistor R8, R10 are coupled to each other in series and are coupled across each of the array of capacitors. In this way, the first resistor R9 and second resistor R8 of the first detection section act as a voltage divider for the voltage across capacitors C1, C3 in first array. Similarly, the first resistor R11 and the second resistor R10 in the second detection system act as a voltage divider for the voltage across the capacitors C2, C4 in the second array.

The short circuit detection circuit 240 also comprises a first opto-coupler U1 and a second opto-coupler U2. The first opto-coupler U1 is provided across the second resistor R8 of the first detection section while the second opto-coupler U2 is provider across the second resistor R10 of the second detection section.

The opto-couplers U1, U2 comprise an LED (light emitting diode) which generates light when a voltage equal or above a threshold voltage Vmin is applied. The opto-couplers U1, U″ further comprise a sensor, such as a phototransistor which is sensitive to light emitted by the LEDs. The sensor is coupled to a first output terminal B and a second output terminal C. When the sensor detects light from the LED it maintains conduction between the first output terminal B and the second output terminal C.

In the example shown in FIG. 2, the first resistors R9, R11 have a resistance of 100k, while the second resistors R8, R10 have a resistance of 1k. Furthermore, Vmin for the opto-couplers U1, U2 is 1V. Accordingly, the minimum voltage required across capacitors C1, C3 of the first array or capacitors C2, C4 of the second array to cause the LED of the associated opto-coupler to turn on is 101V (e.g. required voltage across C1=VC1=(R9/R8+1)*Vmin=(100/1+1)*1=101V).

Accordingly, should the voltage across a capacitor C1, C2, C3, C4 drop below a threshold value of around 101V then the associated opto-coupler U1, U2 will cease to conduct between terminals B and C. During normal conditions, the voltage across each capacitor C1, C2, C3, C4 is constant but when one of these is shorted through failure the voltage rapidly drops, and this change can be observed by the status in the connection at terminals B and C.

The capacitor filter circuit 240 provides a fault signal, which varies according to whether the connection B-C at both opto-couplers U1, U2 is in place. The fault signal may be processed before reaching controller 260. In particular, in the preferred embodiment shown in FIG. 2, the fault signal is processed by fault filter circuit 250 before reaching controller 260 at CapFault.

The fault filter circuit comprises a transistor Q1 and resistors R1, R2, R7, R14. The fault filter circuit 250 further comprises a capacitor C8.

Resistor R7 is provided to pass leakage current from opto-couplers U1, U2. The combination of resistor R14 and capacitor C8 provides a filter network to avoid noise signals due to transient effects in the system. That is to say, transient effects within the fault signal are filtered out before reaching CapFault. Resistor R1 ensures that transistor Q1 remains OFF when either opto-coupler U1, U2 terminal B-C is open.

In normal conditions, the capacitors C1, C2, C3, C4 have a voltage across them which is well above the 101V threshold Vmin for the opto-couplers to turn off. As a result, the terminals B-C in each opto-coupler U1, U2 remains conductively coupled. The transistor Q1 is therefore ON, and current passes through resistor R2 via transistor Q1. Accordingly, a measurement of the fault signal at CapFault is high level

When failure occurs, at least one of the capacitors C1, C2, C3, C4 are shorted, meaning that the voltage across one of the opto-couplers U1, U2 is greatly reduced. In turn this causes the terminals B-C of that opto-coupler to be disconnected (i.e. the circuit is open at this point). As a result, the transistor Q1 is OFF, and accordingly no current flows through R2 and the signal at CapFault is low level.

As such, if the signal at CapFault is low level then a shorting of at least one capacitor C1, C2, C3, C4 in the capacitor filter circuit 230 can be identified. Accordingly, the system further comprises a controller 260, which acts to open switch S1 in the soft start circuit 220 when a low level is detected at CapFault. Accordingly, current is now required to pass through resistor R3, which thereby takes a significant portion of the load from the remaining capacitors C1, C2, C3, C4 in the system and limit large currents that may damage the rectifying circuit 210. In this condition, the controller 260 acts to limit current across the capacitor filter circuit 230. The controller 260 may additionally or alternatively cut off the supply at source couplings L1, L2, L3.

As such, it is not necessary to rely on fuses F1, F2, F3, F4 to prevent damage to components when a capacitor C1, C2, C3, C4 fails, and they are not blown. Furthermore, the fuses do not need to be replaced to recover from any failure. Moreover, the failure of a single capacitor C3 is recognised immediately, whereas in relying on a fuse F1, F2, F3, F4 significant current may only occur once further capacitors fail, thereby shorting the connection across the entire capacitor filter circuit 230. Accordingly, the approach adopted can reduce the amount of components that are damaged in a failure condition.

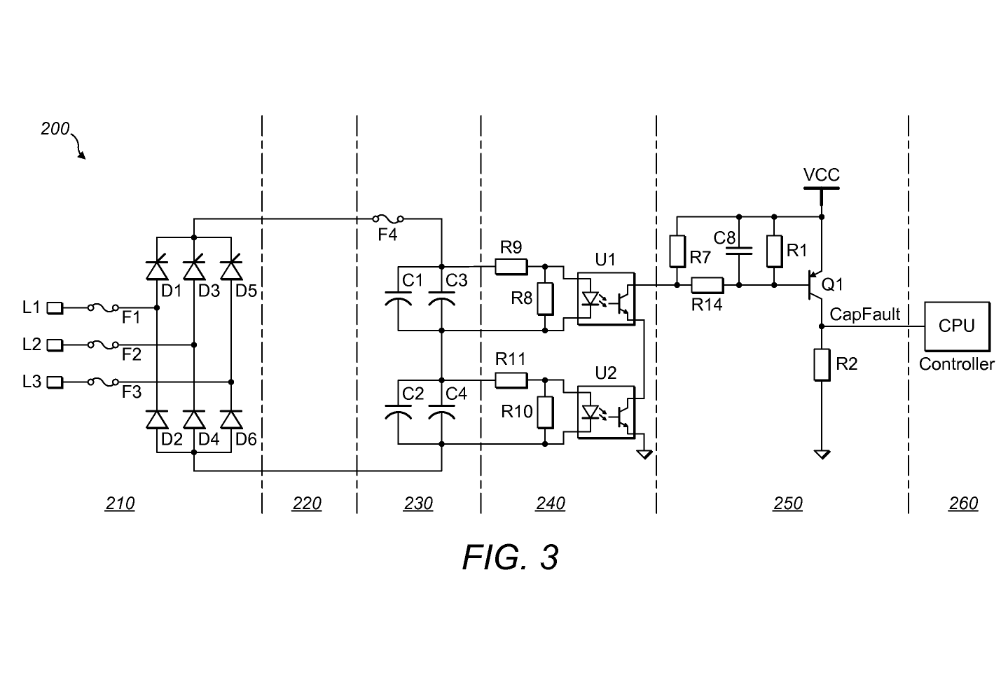

Various variations and modifications of the system described above are possible. For example, instead or in addition to providing a soft start circuit 220, a directly controlled rectifying circuit 210 may be provided. A second preferred embodiment comprising a half-controlled rectifying circuit 210 is illustrated in FIG. 3.

In the second preferred embodiment, there is no soft start circuit 220. Instead control can be effected by thyristors D1, D3, D5 which take the place of the equivalent diodes in the first preferred embodiment. Thyristors are alternatively referred to as Silicon Controlled Rectifiers (SCRs). Control of the rectified signal that is emitted from the rectifying circuit 210 can be effected by control of the firing angle associated with each thyrister D1, D3, D5.

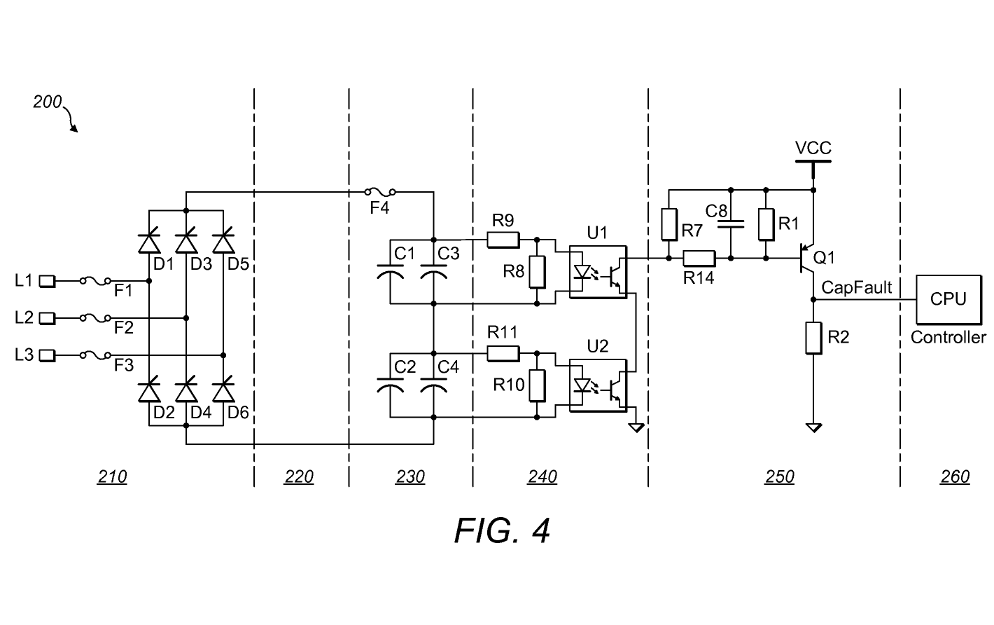

In a third preferred embodiment, the rectifying circuit 210 is a fully controlled rectifying circuit 210. In this case, all diodes, D1, D2, D3, D4, D5, D6 are replaced by thyristers. Again, control can be effected via modification of the firing angle of the thyristers. An example of such a circuit is shown in FIG. 4.

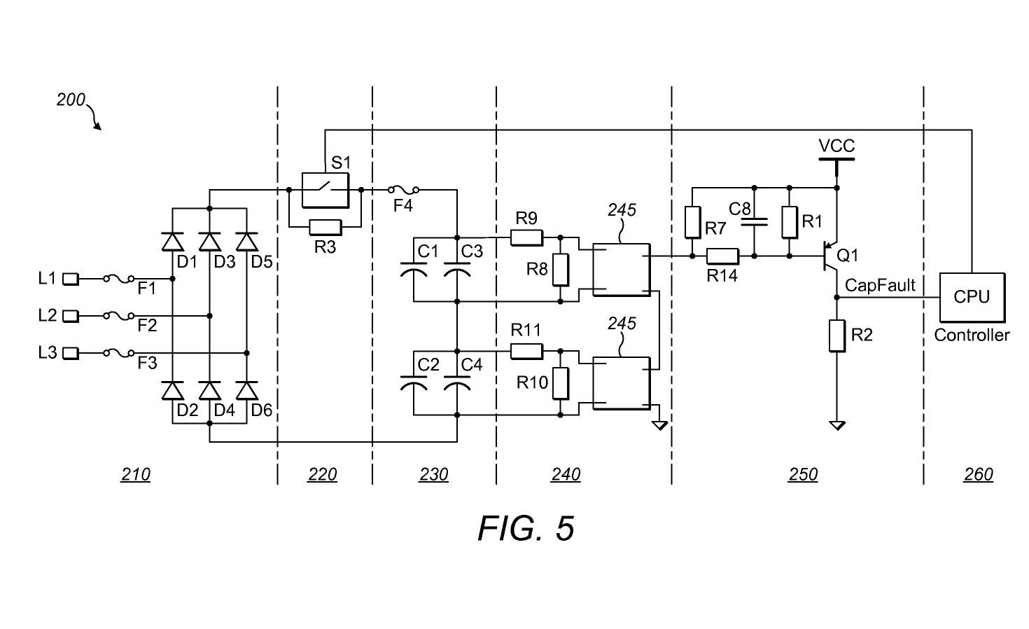

It should also be recognised that alternative mechanisms for detecting changes in the voltage across the capacitors C1, C2, C3, C4 in the capacitor filter circuit 230 may also be adopted in place or in addition to the opto-couplers U1, U2. FIG. 5 illustrates a further preferred embodiment, in which a voltage sampling circuit 245 is provided for each capacitor array. In this embodiment, the voltage sampling circuit 245 is arranged to modify an output signal when the voltage across a capacitor drops below 100V. This causes an identifiable change at CapFault.

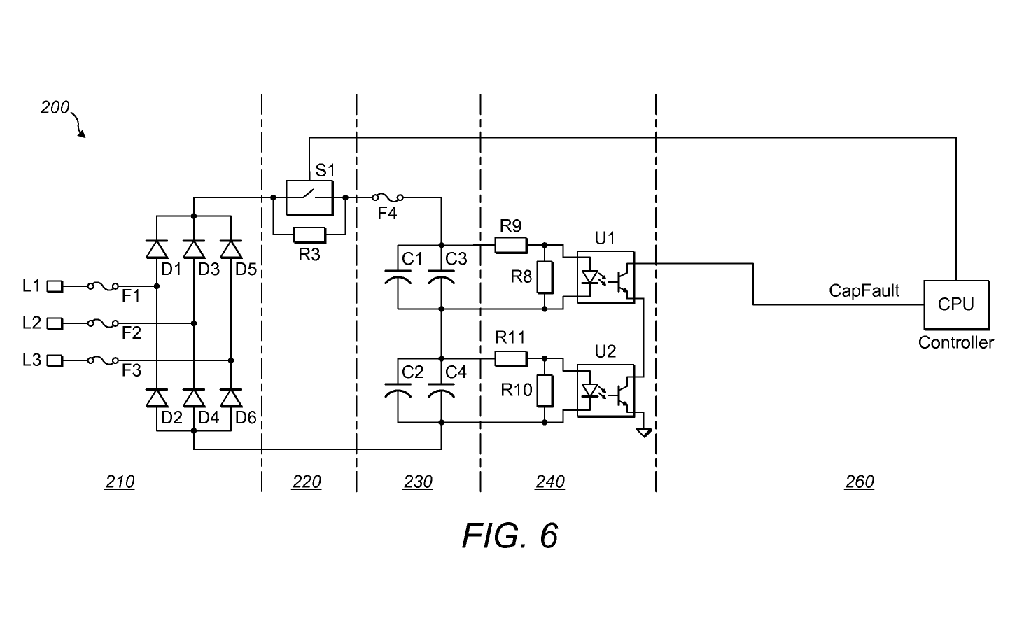

The above preferred embodiments comprise a fault filter circuit 250. However, in some environments such a circuit may not be required or preferred. Thus in a further embodiment, illustrated in FIG. 6, the CapFault signal is retrieved directly from the opto-couplers U1, U2 without passing through a filter circuit.

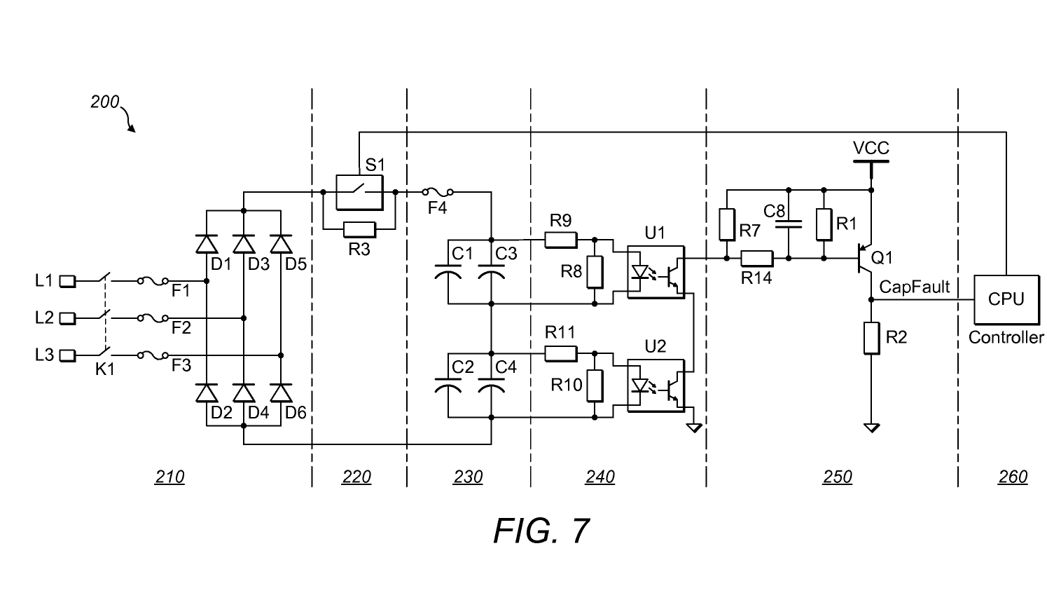

As mentioned above, it is possible that the supply when a fault is detected may be switched at the source L1, L2, L3. FIG. 7 shows a further embodiment in which a contactor is provided adjacent to the source L1, L2, L3 to allow power to be switched off when a fault is detected.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination. For example, the use of half-controlled or fully controlled rectifying circuits 210 such as those illustrated in FIGS. 3 and 4 is not limited to embodiments making use of opto-couplers U1, U2 or fault filter circuits 250. Similarly, additional features may also be incorporated into each of the described embodiments, and the particular values given for parameters such as resistance or capacitance are not limiting.

It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present invention.

1. A direct current source, comprising:
a rectifying circuit coupled to an AC supply, the rectifying circuit being arranged to generate a DC output;
a capacitor filter circuit for smoothing the DC output of the rectifier circuit, the capacitor filter circuit comprising at least one capacitor;
a short circuit detection unit for monitoring at least one voltage across the capacitor filter circuit, the short circuit detection unit being arranged to generate a fault signal in dependence on the monitored voltage; and
a controller for limiting current through the capacitor filter circuit when the fault signal implies that a monitored voltage has fallen below a threshold value.

2. A source according to claim 1, wherein the capacitor filter circuit comprises a plurality of capacitor arrays, each capacitor array being connected in series and comprising one or more capacitors connected in parallel, and wherein the short circuit detection unit is arranged to monitor voltage across one or more of the capacitor arrays.

3. A source according to claim 2, wherein each capacitor array comprises at least two capacitors in parallel

4. A source according to claim 1, further comprising a soft start circuit comprising a switch and a resistor in parallel, wherein the controller is adapted to open the switch when the fault signal implies that the monitored voltage has fallen below a threshold value.

5. A source according to claim 1, wherein the short circuit detection unit comprises one or more opto-couplers.

6. A source according to claim 1, further comprising a fault filter circuit coupled to the output of the short circuit detection unit, the fault filter circuit being arranged to reduce transient effects in the fault signal.

7. A source according to claim 1, wherein the rectifying circuit is a three-phase rectifying circuit.

8. A source according to claim 1, wherein the rectifying circuit is a full wave rectifying circuit.

9. A method for providing a DC source, comprising
rectifying an AC source to provide a DC output;
smoothing the DC output using a capacitor filter circuit, the capacitor filter circuit comprising at least one capacitor;
monitoring a voltage across the at least one capacitor, and generating a fault signal in dependence on the monitored voltage; and
limiting current across the capacitor filter circuit when the fault signal implies that a monitored voltage has fallen below a threshold value.

10. A method according to claim 9, wherein the capacitor filter circuit comprises a plurality of capacitor arrays, each capacitor array being connected in series and comprising one or more capacitors connected in parallel, and wherein the short circuit detection unit is arranged to monitor voltage across one or more of the capacitor arrays.

11. A method according to claim 10, wherein each capacitor array comprises at least two capacitors in parallel.

12. A method according to claim 9, wherein the step of limiting current through the capacitor filter circuit when the fault signal implies that a monitored voltage has fallen below a threshold value comprises opening a switch is a soft start circuit comprising a switch and a resistor in parallel.

13. A method according to claim 9, further comprising filtering the fault signal to reduce the influence of transient effects.
